(19) United States
(12) Patent Application Publication
(10) Pub. No.: US 2018/0250598 A1
(43) Pub. Date: Sep. 6, 2018

(54) SYSTEM AND METHOD FOR MANAGING ONLINE GAMING LEAGUE

(71) Applicants: Sony Interactive Entertainment LLC, SAN MATEO, CA (US); Sony Interactive Entertainment Inc., Tokyo (JP)

(72) Inventors: Steven Trombetta, San Mateo, CA (US); Christopher Thielbar, Tokyo (JP)

(21) Appl. No.: 15/448,356

(22) Filed: Mar. 2, 2017

(51) Int. Cl. A63F 13/798; A63F 13/35; A63F 13/46

(52) U.S. Cl. CPC A63F 13/798; A63F 13/46; A63F 13/35

(57) ABSTRACT

The subject disclosure relates to systems and methods for managing an online gaming digital gaming league. In some aspects, a process of the subject technology can include operations for receiving a plurality of game-performance attributes from a league organizer, the game-performance attributes providing two or more criteria for measuring performance relative to a game title, receiving a game performance dataset, the game performance dataset comprising game-play statistics for each of a plurality of players, and determining a skill level for each of the players based on the game-performance attributes and the game-play statistics for each respective player. In some aspects, the method may further include operations for automatically ranking the players based on the respectively determined skill levels.

### BACKGROUND

### 1. Technical Field

Aspects of the subject technology relate to the creation and management of online gaming leagues, and in particular, to an online platform for automatically managing player rankings in a developer or player initiated online gaming competition.

### 2. Description of the Related Art

Like any popular competitive activity, such as football, card games and board games, online games have a large following of fans that appreciate competitive games and highly skilled players. As with other games, such fans also enjoy structured competition amongst peers of comparable skill level. For example, by encouraging a competitive atmosphere amongst peers, fantasy sports leagues and competitions have become a widespread activity. While fantasy leagues for a variety of sports are now widely available, comparable leagues for online games are not readily available for non-professional players.

### SUMMARY OF THE CLAIMED INVENTION

Embodiments of the claimed invention may include methods and systems for managing an online gaming league. Such systems may include a network interface that receives a plurality of game-performance attributes from a league organizer and a game performance dataset that includes game-play statistics for each of a plurality of players. The game-performance attributes may provide two or more criteria for measuring performance relative to a game title. Systems may further include processors that execute instructions stored in non-transitory memory to automatically rank the players based on the game-performance attributes and the game-play statistics for each respective player.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates an example of a network environment in which some aspects of the technology can be implemented.

FIG. 2 illustrates steps of an example process for automatically ranking game players in an online gaming league.

FIG. 3 illustrates steps of an example process for monitoring online gameplay for a plurality of players, and compiling gameplay statistics into a performance data set.

FIG. 4 illustrates an example of an electronic system with which some aspects of the subject technology can be implemented.

### DETAILED DESCRIPTION

The detailed description set forth below is intended as a description of various configurations of the subject technology and is not intended to represent the only configurations in which the technology can be practiced. The appended drawings are incorporated herein and constitute a part of the detailed description. The detailed description includes specific details for the purpose of providing a more thorough understanding of the technology. However, it will be clear and apparent that the technology is not limited to the specific details set forth herein and may be practiced without these details. In some instances, structures and components are shown in block diagram form in order to avoid obscuring the concepts of the subject technology.

Competitive gaming, commonly referred to as electronic sports or “eSports,” involve the play of video games in a competitive environment. Videogame competitions have existed for nearly as long as video games themselves. Early competitions were set up as tournament style matches between players focused on one particular game, often tied to a new product release. Eventually, competitive leagues and a constant stream of tournaments evolved to provide structure for the eSports community. Players now have the option of competing in a vast array of professional and amateur competitions held at physical locations or in virtual competitions conducted online. Leagues and content providers such as Major League Gaming (MLG), and Global StarCraft® League, provide opportunities for competition and to find information about competitive gaming. Until recently, participation in competitive gaming has demonstrated a gradual and steady pace in growth. However, competitive gaming is presently undergoing a rapid expansion in participation and interest.

Unlike fantasy gaming leagues, such as fantasy football, non-professional players of online games have limited ability to create and manage their own leagues in which players a similar skill level can compete. Additionally, online gamers lack access to a centralized platform that can be readily configured to perform player rankings, and that are based on player determined metrics and/or attributes. Accordingly, it would be desirable to provide a gaming platform to flexibly permit the creation of leagues by both professional and non-professional players, as well as to manage the automatic scoring and ranking of players based on developer and/or player determined metrics.

The subject technology addresses the foregoing limitations by providing a gaming league platform that facilitates the creation and management of customized gaming leagues. In some aspects, the gaming league platform can be configured to receive various game performance attributes, for example, from a league organizer that specify various attributes to be used for ranking competitive users/players for a particular game title. The game-performance attributes can vary depending upon several factors including the type of game played, player skill level, and league competition parameters, etc.

Using the specified game-performance attributes, players can then be compared/ranked based on gameplay statistics that describe player performance within the game environment. As discussed in further detail below, game-performance attributes can also be used to specify conditions for the particular league in which the competition is conducted. For example, game performance attributes can be used to set a duration of the league's competition (i.e., a “season” length), a requisite skill level for inclusion in the league, and/or specific parameters for restricting participation to certain players, e.g., an access control list.

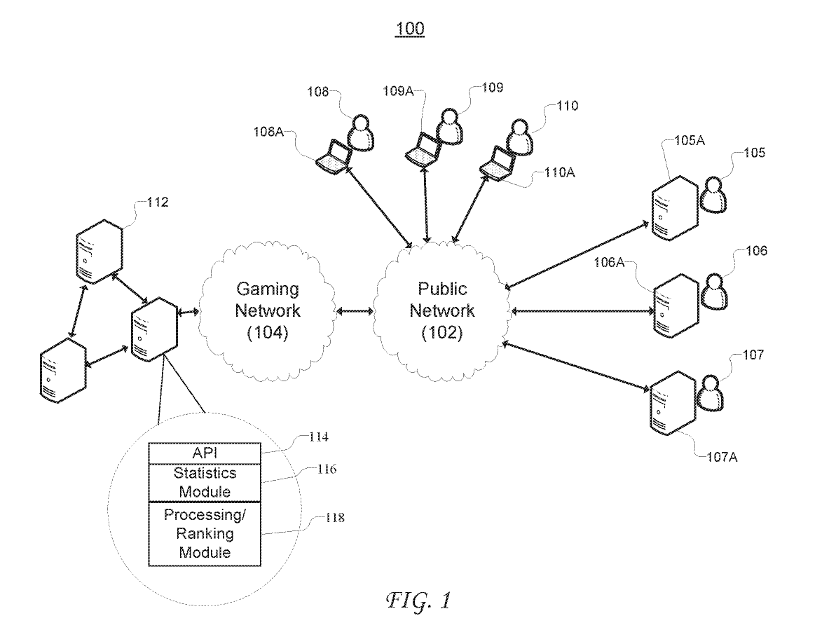

FIG. 1 illustrates an example of network environment 100 in which some aspects of the technology can be implemented. Environment 100 includes public network 102, which can include one or more private networks, such as, a local area network (LAN), a wide area network (WAN), or a network of public/private networks, such as the Internet. Public network 102 is communicatively coupled to gaming network 104 that represents a network of computing resources configured for implementing gaming league management system 112 of the subject technology.

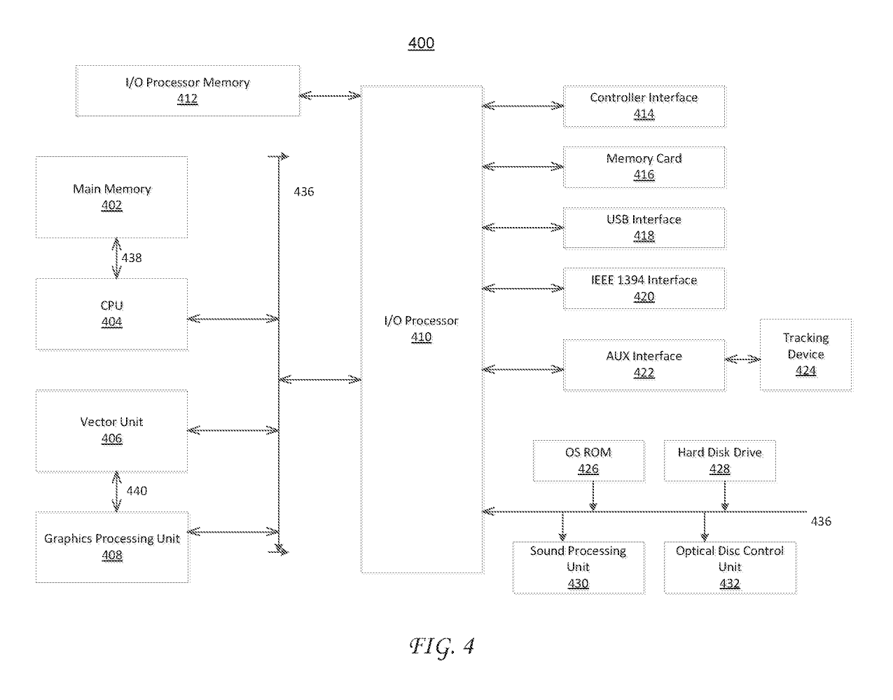

Public network 102, and gaming network 104 provide player and developer access to league management system 112. As illustrated, players 108, 109, and 110 are permitted access to league management system 112 using respective client devices (e.g., 108A, 109A, and 110A). Although client devices 108A, 109A, and 110A, are depicted as personal computing devices, it is understood that the client devices can include various types of processor-based systems, including but not limited to: game consoles, smart phones, tablet computer systems, and the like. Example of hardware systems that can be used to implement the client device are discussed in further detail below with respect to FIG. 4. Similarly, developers (e.g., 105, 106 and 107), are permitted access to league management system via respective their computing systems (e.g., 105A, 106A, and 107A).

It is understood that a greater (or fewer) number of players and/or developers can be engaged with environment 100, without departing from the scope of the technology.

In practice, league management system 112 is configured to create and support tournament style competitions between various players and for various game titles. As discussed in further detail below, management system 112 can also be configured to support competitions between players for multiple game titles, for example, to facilitate player competition across game genres, such as, real-time strategy (RTS) games, adventure games, puzzle games, and the like.

Because the metrics that are used to evaluate player performance for a particular game can vary widely between game title and type, in some aspects, game developers are encouraged to provide an indication of the specific game-performance attributes that should be used to evaluate player performance for the developer's game.

By way of example, developers 105, 106, and/or 107 can be developers of different game titles, each of which is associated with a different genre. To facilitate league competition for their games, each of the developers can submit game-performance attributes to the league, e.g., using respective computing systems 105A, 106A, and 107A. In a similar manner, the creation of gaming leagues and corresponding league parameters can be managed at the player level, for example by one or more of players 108, 109, and/or 110. That is, individual players or player collectives can provide specific game-performance attributes that they would like implemented to structure their own individualized league play.

Although game-performance attributes can include virtually any type of information that can be used in conjunction with the creation, execution, management, and/or promotion of a gaming league, in some aspects, game-performance attribute information can include one or more of: a “match type,” “event information,” and/or a player access list, etc.

In some embodiments, match type information can be used to specify a game mode for the league that can include various characteristics, such as game duration, level of competition, or other distinct features such as a specific map to be played, and/or strategies to be implemented. Event information can be used to specify one or more conditions or actions that, if performed in the gameplay environment, increase or decrease the player's evaluation with respect to other players. In some aspects, the player access list can be used to specify specific players that should be included (or excluded) from competition in a given league, for example, based on their associated player name, online identification, past performance, and/or player history information, etc.

The game-performance attributes can be received by league management system 112, for example, using an application programming interface (API), such as API 114. Subsequently, the game-performance attributes can be passed from API 114 to statistics module 116 for use in player analysis. In a similar manner, game-play statistics can be collected by API 114 and passed to statistics module 116. Depending on implementation, gameplay statistics can be collected via active monitoring of an online game environment, or received from one or more external systems, for example, as part of a game performance data set that includes information describing individual player performance for one or more game titles and/or genre categories.

Once league competition has concluded, league management system 112 can use the game performance attributes, and gameplay statistics to determine a skill level for each player in a given league, e.g., using processing/ranking module 118. Determinations of skill level can vary depending upon the specified game performance attributes, and can vary between game titles, and/or game genres. By way of example, skill level for a given player can be based on one or more of: collected points, a number of wins/losses, total game time, achieve difficulty level, and/or a number of “kills,” etc.

In some aspects, at the conclusion of league competition, designations of achievement can be provided based on the overall ranking of a player or group of players. For example, digital trophies or medals can be provided to the top-ranked player (or player team), and published on an associated player (or team) profile. By publishing player (or team) accomplishments, competition can be encouraged amongst users of the online gaming environment, either on a game-by-game basis, a league-by-league basis, or across various game genres.

In some aspects, players in a given league can be ranked into multiple categories or “tiers.” By way of example, a “platinum” tier may be designated for the top 2% of players, a “gold” tier designated for the subsequent 20% of players, a “silver” tier designated for the next 28% of players, and a “bronze” tier designated for the last 32%, etc.

The ranking of players within a given league also facilitates the ranking of various leagues into league hierarchies. For example, players categorized into the top tier of their respective league at the conclusion of a league competition may have the option of joining a higher league once competition resumes, i.e. in the subsequent “season.” Similarly, low performing players may be demoted down the league hierarchy once competition resumes.

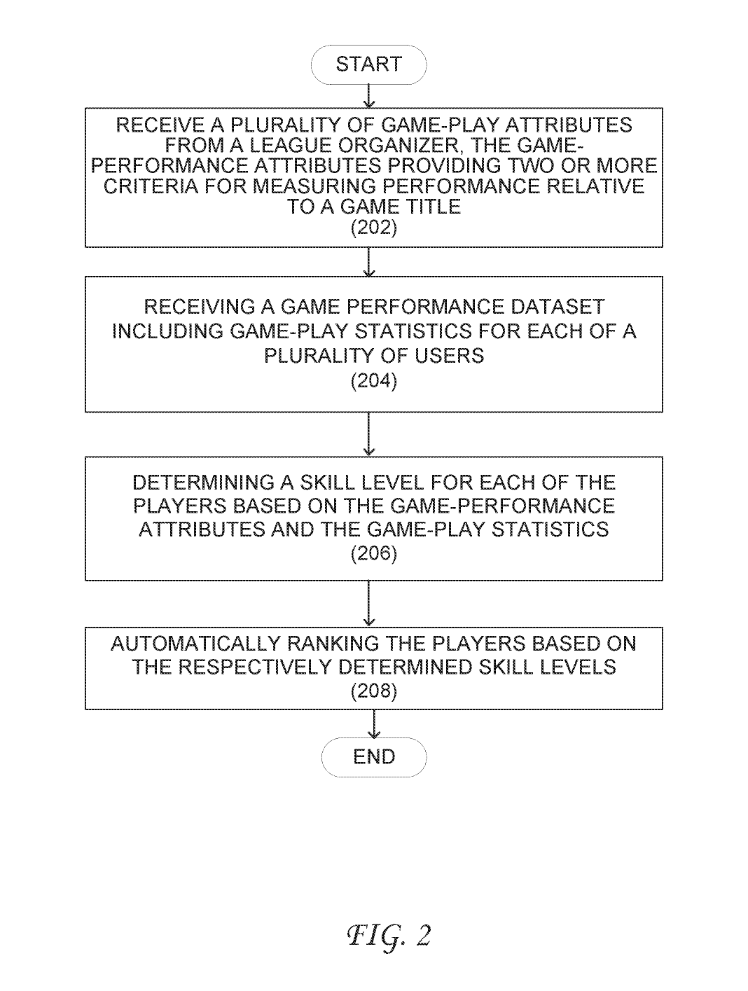

FIG. 2 illustrates steps of an example process 200 for automatically ranking game players in an online gaming league. Process 200 begins with step 202 in which a plurality of gameplay attributes are received from a league organizer. As discussed above, the league organizer can be virtually any party interested in creating a league for competitive online gameplay. For example, league organizers can include individual players (e.g., players 108, 109, and 110) or game developers (e.g., developers 105, 106, and 107), as discussed above. However, it is understood that other entities may also provide gameplay attributes necessary to organize league competition, without departing from the scope of the technology.

In step 204, a game performance dataset is received that includes gameplay statistics for each of a plurality of players competing in league competition. Gameplay statistics can be received as a result of a monitoring process, for example, that involves recording/storing gameplay statistics based on player performance in playing a video game for a specific game title. As discussed above, gameplay statistics for a particular player can include information regarding any aspect of the player's performance or participation in an online game environment. For example, gameplay statistics can include indications of a number of wins/losses incurred by the player, a difficulty level achieved by the player, a total time spent playing or engaged in the game environment, a number of points accumulated for various accomplishments/actions within the game environment, and/or an ELO score associated with the player.

In step 206, a skill level is determined for each of the players based on the received game performance attributes, and the gameplay statistics. In some implementations, the determination of a skill level for each player is based on a weighted calculation performed with respect to the respective player's gameplay statistics, wherein some statistical factors are given greater weight. For example, depending on user/developer preference, a number of wins may be more highly weighted than the amount of time spent playing the game, i.e., a total game time. It is understood that various gameplay statistics can be more heavily (or less heavily) weighted in the overall calculation of player skill level, depending on the configuration of the league dictated by the received gameplay attributes.

In step 208, a ranking of the players automatically performed based on each of the players' respectively determined skill level. A ranking of the players can be used to categorize various players into skill-based “tiers,” and used to provide various indicia of player achievement. By way of example, highly performing players may be provided with digital trophies (e.g., medallions or ribbons, etc.) that can be displayed on the player's gaming profile to indicate their achievement or gaming prowess to other players.

As discussed above, ranking can also be performed between various gaming leagues and/or cross entire game genres. For example, player ranking statistics can be automatically determined for an entire collection of game titles belonging to a similar genre, such as, “first person shooter” games, or “real-time strategy” games, etc.

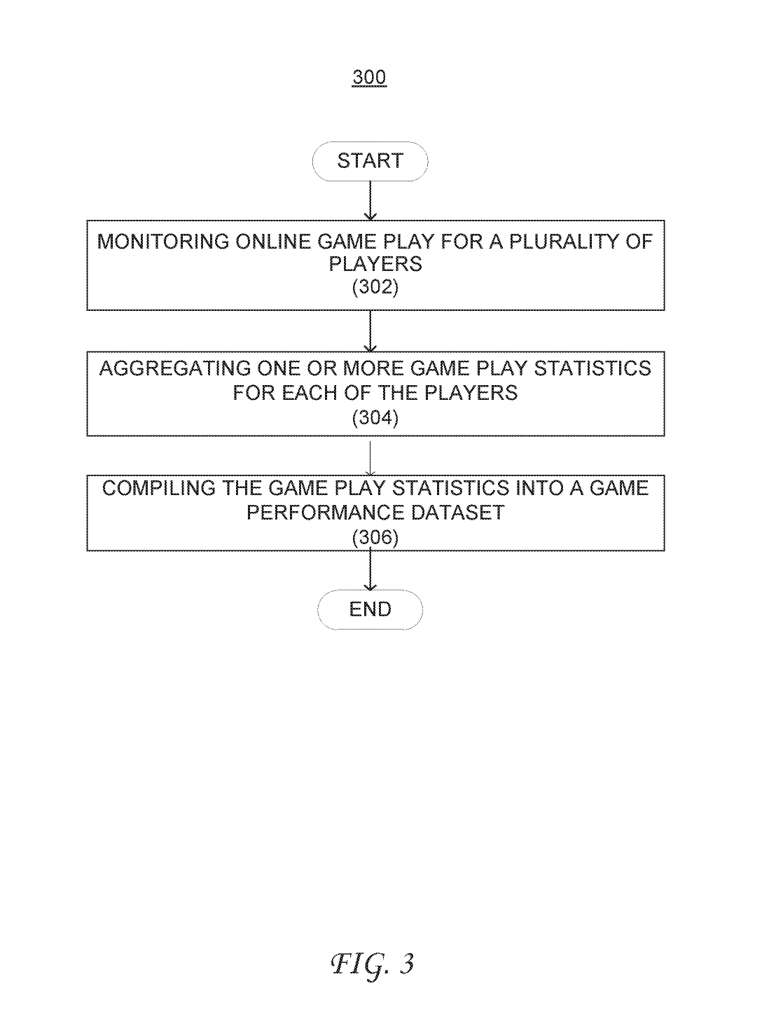

In other aspects, gameplay statistics may be received through active monitoring of gameplay in one or more online digital environment. For example, FIG. 3 illustrates steps of an example process 300 for monitoring online gameplay for multiple players, and compiling the gameplay statistics into a performance data set.

Process 300 begins with step 302 in which online gameplay for one or more players is actively monitored, for example, to determine the occurrence (or nonoccurrence) of certain predetermined events or conditions. By way of example, gameplay can be monitored to determine a total play time for a user, achieved high scores, a number of “kills” or highest level achieved, etc. Subsequently, at step 304, gameplay statistics for each user can be aggregated, and at step 306 compiled into a game performance dataset.

As discussed above, the game performance dataset can be used to represent chunks of information regarding game play statistics for one or more users in a league, or in some instances, for statistics pertaining to multiple players across multiple leagues. Further to the aspects discussed above with respect to FIG. 1, the game performance dataset can be provided to a league management system (e.g., league management system 112), and used to perform rankings of players in a given league, or to preform ranking of leagues within a league hierarchy.

FIG. 4 is an exemplary user device 400. User device 400 (e.g., desktop, laptop, tablet, mobile device, console gaming system) is a device that the user can utilize to facilitate carrying out features of the present invention pertaining to the viewing of third party content.

The user device 400 may include various elements as illustrated in FIG. 4. It should be noted that the elements are exemplary and that other embodiments may incorporate more or less than the elements illustrated. With reference to FIG. 4, the user device 400 includes a main memory 402, a central processing unit (CPU) 404, at least one vector unit 406, a graphics processing unit 408, an input/output (I/O) processor 410, an I/O processor memory 412, a controller interface 414, a memory card 416, a Universal Serial Bus (USB) interface 418, and an IEEE 1394 interface 420, an auxiliary (AUX) interface 422 for connecting a tracking device 424, although other bus standards and interfaces may be utilized. The user device 400 further includes an operating system read-only memory (OS ROM) 426, a sound processing unit 428, an optical disc control unit 430, and a hard disc drive 432, which are connected via a bus 434 to the I/O processor 410. The user device 400 further includes at least one tracking device 424.

The tracking device 424 may be a camera, which includes eye-tracking capabilities. The camera may be integrated into or attached as a peripheral device to user device 400. In typical eye-tracking devices, infrared non-collimated light is reflected from the eye and sensed by a camera or optical sensor. The information is then analyzed to extract eye rotation from changes in reflections. Camera-based trackers focus on one or both eyes and record their movement as the viewer looks at some type of stimulus. Camera-based eye trackers use the center of the pupil and light to create corneal reflections (CRs). The vector between the pupil center and the CR can be used to compute the point of regard on surface or the gaze direction. A simple calibration procedure of the viewer is usually needed before using the eye tracker.

Alternatively, more sensitive trackers use reflections from the front of the cornea and that back of the lens of the eye as features to track over time. Even more sensitive trackers image features from inside the eye, including retinal blood vessels, and follow these features as the eye rotates.

Most eye tracking devices use a sampling rate of at least 30 Hz, although 50/60 Hz is most common. Some tracking devises run as high as 1250 Hz, which is needed to capture detail of very rapid eye movement.

A range camera may instead be used with the present invention to capture gestures made by the user and is capable of facial recognition. A range camera is typically used to capture and interpret specific gestures, which allows a hands-free control of an entertainment system. This technology may use an infrared projector, a camera, a depth sensor, and a microchip to track the movement of objects and individuals in three dimensions. This user device may also employ a variant of image-based three-dimensional reconstruction.

The tracking device 424 may include a microphone integrated into or attached as a peripheral device to user device 400 that captures voice data. The microphone may conduct acoustic source localization and/or ambient noise suppression.

Alternatively, tracking device 424 may be the controller of the user device 400. The controller may use a combination of built-in accelerometers and infrared detection to sense its position in 3D space when pointed at the LEDs in a sensor nearby, attached to, or integrated into the console of the entertainment system. This design allows users to control functionalities of the user device 400 with physical gestures as well as button-presses. The controller connects to the user device 400 using wireless technology that allows data exchange over short distances (e.g., 30 feet). The controller may additionally include a “rumble” feature (i.e., a shaking of the controller during certain points in the game) and/or an internal speaker.

The controller may additionally or alternatively be designed to capture biometric readings using sensors in the remote to record data including, for example, skin moisture, heart rhythm, and muscle movement.

As noted above, the user device 400 may be an electronic gaming console. Alternatively, the user device 400 may be implemented as a general-purpose computer, a set-top box, or a hand-held gaming device. Further, similar user devices may contain more or less operating components.

CPU 404, vector unit 406, graphics processing unit 408, and I/O processor 410 communicate via system bus 436. Further, the CPU 404 communicates with the main memory 402 via a dedicated bus 438, while the vector unit 406 and the graphics processing unit 408 may communicate through a dedicated bus 440. The CPU 404 executes programs stored in the OS ROM 426 and the main memory 402. The main memory 402 may contain pre-stored programs and programs transferred through the I/O Processor 410 from a CD-ROM, DVD-ROM, or other optical disc (not shown) using the optical disc control unit 432. The I/O processor 410 primarily controls data exchanges between the various devices of the user device 400 including the CPU 404, the vector unit 406, the graphics processing unit 408, and the controller interface 414.

The graphics processing unit 408 executes graphics instructions received from the CPU 404 and the vector unit 406 to produce images for display on a display device (not shown). For example, the vector unit 406 may transform objects from three-dimensional coordinates to two-dimensional coordinates, and send the two-dimensional coordinates to the graphics processing unit 408. Furthermore, the sound processing unit 430 executes instructions to produce sound signals that are outputted to an audio device such as speakers (not shown).

A user of the user device 400 provides instructions via the controller interface 414 to the CPU 404. For example, the user may instruct the CPU 404 to store certain information on the memory card 416 or instruct the user device 400 to perform some specified action.

Other devices may be connected to the user device 400 via the USB interface 418, the IEEE 1394 interface 420, and the AUX interface 422. Specifically, a tracking device 424, including a camera or a sensor may be connected to the user device 400 via the AUX interface 422, while a controller may be connected via the USB interface 418.

It is understood that any specific order or hierarchy of steps in the processes disclosed is an illustration of exemplary approaches. Based upon design preferences, it is understood that the specific order or hierarchy of steps in the processes may be rearranged, or that only a portion of the illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.”

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

1. A system for managing an online gaming league, the system comprising:
one or more processors;
a network interface coupled to the one or more processors; and
a non-transitory memory coupled to the one or more processors, the non-transitory memory comprising instructions stored therein, which when executed by the processors, cause the one or more processors to perform operations comprising:
receiving, via the network interface two or more game-performance criteria for measuring game-play of a plurality of players relative to a game title in the online gaming league;
monitoring, game-play statistics for the plurality of players, the game-play statistics corresponding to the two or more game-performance criteria over a season of game-play;
compiling the game-play statistics for at least a portion of the season into a game performance dataset;
ranking each player based on at least the game performance dataset;
assigning a sub-set of the plurality of players to a tier in the online gaming league based on a rank for each player; and
inviting at least one player from the sub-set of players to participate in a new season of game-play in the online gaming league.

2. The system of claim 1, wherein assigning the sub-set of the plurality of players to the tier further includes:
determining a skill level for each of the plurality of players based on the game-performance attributes and the game-play statistics for each respective player.

3. The system of claim 2, wherein the skill level includes a point score consisting of player points accumulated during online play of the game title.

4. The system of claim 2, wherein the skill level includes a number of wins and a number of losses for online play of the game title.

5. The system of claim 2, wherein the skill level includes an ELO score.

6. The system of claim 1, wherein execution of the instructions by the one or more processors further causes the one or more processors to perform operations comprising:
identifying a top-ranked player from among the sub-set of the plurality of players; and
indicating a ranking status for the top-ranked player in a user profile associated with the top-ranked player.

7. The system of claim 1, wherein the instructions for receiving the two or more game-performance criteria includes receiving the two or more game-performance criteria from a developer of the game title.

8. The system of claim 7, wherein the developer is a player of the game title.

9. A method for managing an online gaming league, the method comprising:
receiving two or more criteria for measuring game-play performance of a plurality of players relative to a game title in the online gaming league;
monitoring game-play statistics for the plurality of players, the game-play statistics corresponding to the two or more game-performance criteria over a season of game-play in the online gaming league;
compiling the game-play statistics for at least a portion of the season into a game performance dataset;
ranking each player based at least on the game performance dataset;
assigning a sub-set of the plurality of players to a tier based on a rank for each player; and
inviting at least one player assigned to the tier to participate in a new season of game-play in the online gaming league.

10. The method of claim 9, wherein the at least one of the two or more game-performance criteria includes a score of points accumulated during online game-play of the game title.

11. The system of claim 9, wherein at least one of the two or more game-performance criteria includes a number of wins and a number of losses for online game-play of the game title.

12. The method of claim 9, wherein at least one of the two or more game-performance criteria includes an ELO score.

13. The method of claim 9, further comprising:
identifying a top-ranked player from among the sub-set of the plurality of players; and
indicating a ranking status for the top-ranked player in a user profile associated with the top-ranked player.

14. The method of claim 9, wherein receiving the two or more game-performance criteria includes receiving the two or more game-performance criteria from a developer of the game title.

15. The method of claim 7, wherein the developer is a player of the game title.

16. A non-transitory computer-readable storage medium, having embodied thereon a program executable by a processor to perform a method for managing an online gaming league, the method comprising:
receiving two or more criteria for measuring game-play performance of a plurality of players relative to a game title in the online gaming league;
monitoring game-play statistics for the plurality of players, the game-play statistics corresponding to the two or more game-performance criteria over a season of game-play;
compiling the game-play statistics for at least a portion of the season into a game performance dataset;
ranking each player based on at least the game performance dataset;
assigning a sub-set of the plurality of players to a tier in the online gaming league based on a rank for each player; and
inviting at least one player from the sub-set of players to participate in a new season of game-play in the online gaming league.

17. The non-transitory computer-readable storage medium of claim 16, wherein the at least one of the two or more game-performance criteria includes a point-score of points accumulated during online game-play of the game title.

18. The non-transitory computer-readable storage medium of claim 16, wherein at least one of the two or more game-performance criteria includes a number of wins and a number of losses for online game-play of the game title.

19. The non-transitory computer-readable storage medium of claim 16, wherein at least one of the two or more game-performance criteria includes an ELO score.

20. The non-transitory computer-readable storage medium of claim 16, further comprising instructions to cause the processors to perform operations for:
identifying a top-ranked player from among the sub-set of the plurality of players; and
indicating a ranking status for the top-ranked player in a user profile associated with the top-ranked player.
